(19) United States
(12) Patent Application Publication
(10) Pub. No.: US 2022/0245651 A1
(43) Pub. Date: Aug. 4, 2022

(54) SYSTEMS AND METHODS FOR ENHANCED RESOURCE PROTECTION AND AUTOMATED RESPONSE

(71) Applicant: BANK OF AMERICA CORPORATION, Charlotte, NC (US)

(72) Inventors: Elliott Leonard Lillard, Denver, CO (US); Regina Yee Cadavid, San Gabriel, CA (US); Gloria Youngsook Joo, Moorpark, CA (US); Jinyoung Nathan Kim, Charlotte, NC (US); Ram Korlepara, McKinney, TX (US); Nia Mack, Prosper, TX (US); Philip Lone Mintac, Charlotte, NC (US); Srilekha Mudumbai Srinivasa, Murphy, TX (US); Michael Jacob Richardson, Chicago, IL (US); Brandon Sloane, Indian Land, SC (US)

(73) Assignee: BANK OF AMERICA CORPORATION, Charlotte, NC (US)

(21) Appl. No.: 17/165,102

(22) Filed: Feb. 2, 2021

(51) Int. Cl. G06Q 30/00; G06Q 30/02; G06Q 50/18; G06Q 10/10; G06F 16/2457; G06F 16/28; G06N 3/08

(52) U.S. Cl. CPC G06Q 30/0185; G06Q 30/0201; G06Q 50/184; H04L 9/3263; G06F 16/24575; G06F 16/285; G06N 3/08; G06Q 10/10

(57) ABSTRACT

Embodiments of the invention are directed to systems, methods, and computer program products for providing intelligent analysis of technical and non-technical data to identify and categorize use of entity brand elements as authorized or unauthorized. The system provides a single portal view of aggregated information and usage information for brand elements of the entity. The invention further includes the capability to recommend and automate remedial measures to prevent continued unauthorized use of brand elements.

### BACKGROUND

An entity's brand can be formulated using a variety of technical and non-technical elements. The identification of these brand elements is important to track against authorized hosted technologies in order to identify any unauthorized use by external parties. Currently, there is no ideal aggregator of both the technical and non-technical brand intel into a centralized storage and remediation mechanism. A more intelligent and cohesive solution is needed to properly address these issues.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The systems and methods described herein address the above needs by providing intelligent analysis of technical and non-technical data to identify and categorize use of entity brand elements as authorized or unauthorized. Brand elements may include typical marks such as images, logos, or colors, but also technical elements including Domain Name System (DNS) information, digital certificates, Uniform Resource Locators (URLs), or the like. If unauthorized uses of brand elements are identified by the system, the system may provide recommendations to the controlling entity for remediation. The system provides a single portal view of aggregated publicly accessible information and usage information for brand elements of the entity. At a high level, these components may include a brand element inventory tool, active brand tracking agents, aggregation and notification mechanisms, or automated remediation mechanisms.

In some implementations, brand element tracking agents are deployed as both resident on specific elements, and in some embodiments may also be deployed as programs for gathering and analyzing data across a range of data sources both inclusive of common and known platforms (e.g., popular websites, social media platforms, or the like). In some embodiments, brand tracking agents may also be deployed for use on more non-traditional platforms (such as internet relay chat channels or distributed networks). The identification of data sources will vary widely across each implementation and it is important to note that the system is intended to process a wide array of types of information from existing brand element tracking solutions that may exist.

Embodiments of the invention relate to systems, methods, and computer program products for enhanced brand element protection and automated response, the invention including: receive data from one or more data gathering programs or third party sources, wherein the data represents potential brand element use; query a database of existing brand element category examples and perform an analysis of the data in comparison to the brand element category examples via use of a machine learning algorithm; determine a confidence score for the data indicating a percentage likelihood that the data represents use of one or more brand element categories; determine that the use of the one or more brand element categories is unauthorized; and generate an automated remedial action to stop the use of the one or more brand element categories.

In some embodiments, the one or more brand element categories comprises a non-technical brand element including a specific image, a specific logo, or specific color scheme.

In some embodiments, the one or more brand element categories comprises a technical brand element including DNS information, a digital certificate, a domain name, or a URL.

In some embodiments, the data is an image, and the machine learning algorithm comprises neural network image recognition via a convolutional neural network.

In some embodiments, determining that the use of the one or more brand element categories is unauthorized further comprises automatically comparing the data source to a list of authorized digital certificates.

In some embodiments, the invention is further configured to: detect legal entities associated with data from two separate sources and two different brand element categories; determine via a correlation algorithm that the legal entities of the data of the two separate sources and two different brand element categories have some association; generate a confidence score based on the association; and display the association of the data in a graph database format for user visualization.

In some embodiments, the automated remedial action further comprises the automatic drafting of a cease and desist letter targeted to the source of the data.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the brand element protection system, in accordance with one embodiment of the present disclosure;

FIG. 2 is a block diagram illustrating the brand element protection system;

FIG. 3 is a block diagram illustrating a user device associated with the brand element protection system; and

FIG. 4 is a flow diagram illustrating a process using the brand element protection system, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual associated with an entity. As such, in some embodiments, the user may be an individual having past relationships, current relationships or potential future relationships with an entity. In some instances, a “user” is an individual who has a relationship with the entity, such as a customer or a prospective customer. Accordingly, as used herein the term “user device” or “mobile device” may refer to mobile phones, personal computing devices, tablet computers, wearable devices, and/or any portable electronic device capable of receiving and/or storing data therein and are owned, operated, or managed by a user.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

A “brand element” as described herein may refer to marks such as images, logos, or colors which are owned by or registered for exclusive use to a specific entity or person. In some embodiments, brand elements may also vitally include various technical elements including Domain Name System (DNS) information, digital certificates, Uniform Resource Locators (URLs), or the like, which may not typically be easily visually identified by human review as belonging to a specific entity without actively cross-referencing a registry, database, or list of technical brand elements and their respective owners or registrants.

“Agent” as used herein may refer to a computer program or device with the ability to actively collect, gather, scrape, extract, or otherwise infer information related to the usage of a brand element. In preferred embodiments, agents typically must also include such technology that keeps an inventory of all entity-issued certificates for brand element usage and verification, as well as include the ability for provenance tracking for downstream certificate issuance.

The system allows for use of a machine learning engine to intelligently identify information retrieved by agents as potentially indicating use or display of brand elements. The machine learning engine may be used to analyze historical data in comparison to potential uses of brand elements in order to determine a likelihood of a brand element being present. The machine learning engine may also be used to generate intelligent aggregation of similar data based on metadata comparison of technical and non-technical brand elements, which in some cases may be used to generate a graph database visualization of such similarities.

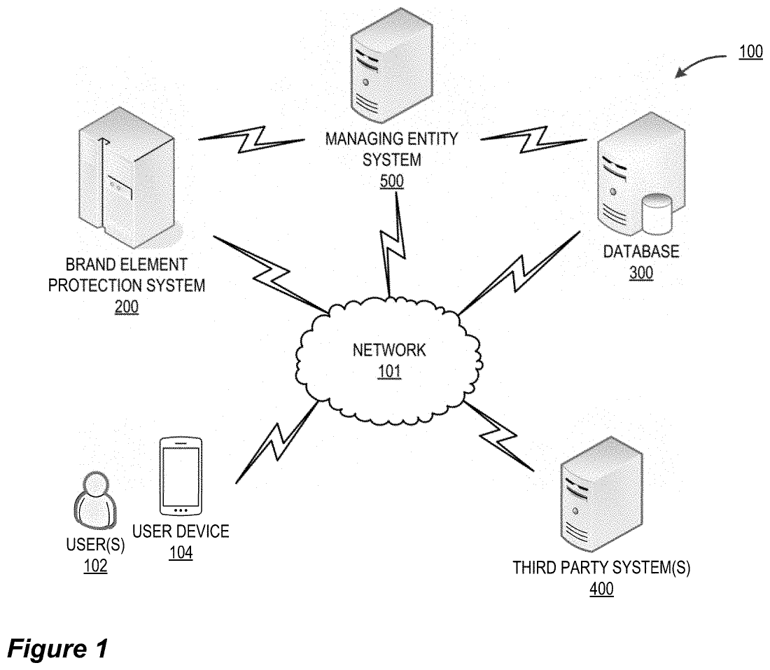

FIG. 1 illustrates an operating environment for the brand element protection system, in accordance with one embodiment of the present disclosure. As illustrated, the operating environment 100 may comprise a user 102 and/or a user device 104 in operative communication with one or more third party systems 400 (e.g., web site hosts, registry systems, third party entity systems, or the like). The operative communication may occur via a network 101 as depicted, or the user 102 may be physically present at a location separate from the various systems described, utilizing the systems remotely. The operating environment also includes a managing entity system 500, a brand element protection system 200, a database 300, and/or other systems/devices not illustrated herein and connected via a network 101. As such, the user 102 may request information from or utilize the services of the brand element protection system 200, or the third party system 400 by establishing operative communication channels between the user device 104, the managing entity system 500, and the third party system 400 via a network 101.

Typically, the brand element protection system 200 and the database 300 are in operative communication with the managing entity system 500, via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the third party system 400). In this regard, the wireless communication channel may further comprise near field communication (NFC), communication via radio waves, communication through the internet, communication via electromagnetic waves and the like.

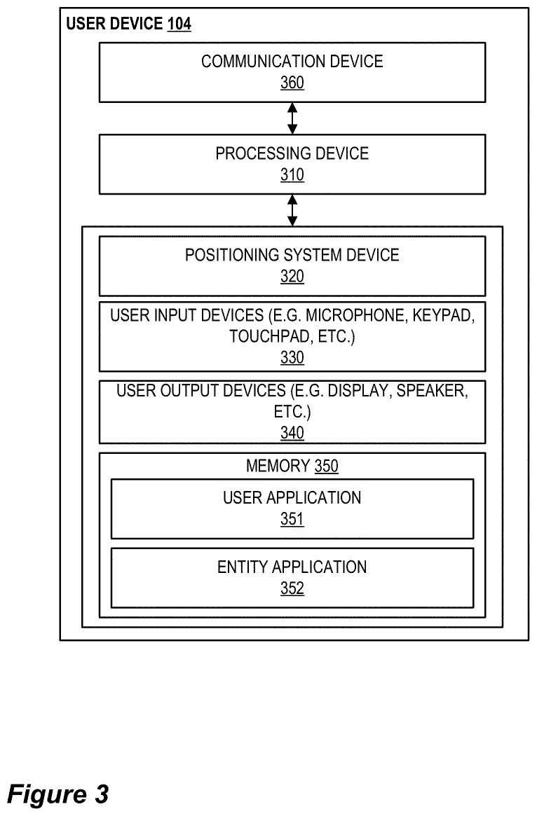

The user device 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. The user device is described in greater detail with respect to FIG. 3.

The managing entity system 500 may comprise a communication module and memory not illustrated, and may be configured to establish operative communication channels with a third party system 400 and/or a user device 104 via a network 101. The managing entity may comprise a brand element data repository 256 which stores brand element data 257 (e.g., a database of brand elements and associated metadata, authorized uses, authorized parties, authorized formats for use, identified uses, unauthorized use history, records of remedial measures taken, or the like). The data repository 256 may also contain user data. This user data may be used by the managing entity to authorize or validate the identity of the user 102 for accessing the system (e.g., via a username, password, biometric security mechanism, 2 factor authentication mechanism, or the like). In some embodiments, the managing entity system is in operative communication with the brand element protection system 200 and database 300 via a private communication channel. The private communication channel may be via a network 101 or the brand element protection system 200 and database 300 may be fully integrated within the managing entity system 500, such as a virtual private network (VPN), or over a secure socket layer (SSL).

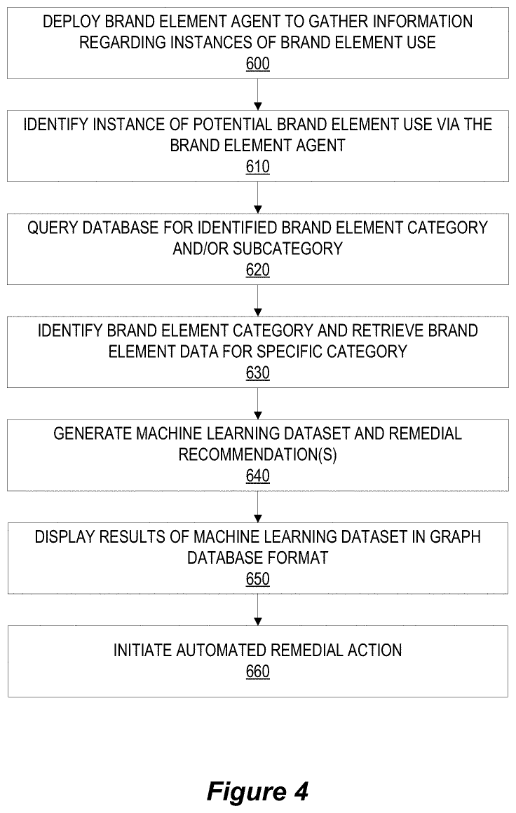

As will be discussed in greater detail in FIG. 4 and FIG. 5, the managing entity system 500 may communicate with the brand element protection system 200 in order to transmit data associated with observed brand element usage by or via a plurality of third party systems 400. In some embodiments, the managing entity may utilize the features and functions of the brand element protection system to initialize remedial measures in response to identifying unauthorized usage of brand elements. In other embodiments, the managing entity and/or the one or more third party systems may utilize the brand element protection system to react to identified trends or identified unauthorized brand element uses.

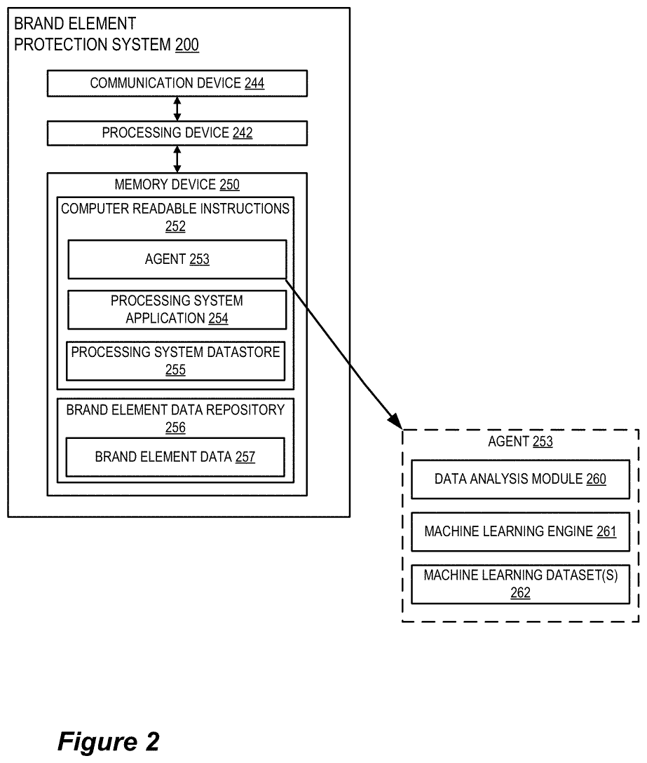

FIG. 2 illustrates a block diagram of the brand element protection system 200 associated with the operating environment 100, in accordance with embodiments of the present invention. As illustrated in FIG. 2, the brand element protection system 200 may include a communication device 244, a processing device 242, and a memory device 250 having an agent module or “agent” 253, a processing system application 254 and a processing system datastore 255 stored therein. As shown, the processing device 242 is operatively connected to and is configured to control and cause the communication device 244, and the memory device 250 to perform one or more functions. In some embodiments, the agent module 253 and/or the processing system application 254 comprises computer readable instructions that when executed by the processing device 242 cause the processing device 242 to perform one or more functions and/or transmit control instructions to the database 300, the managing entity system 500, or the communication device 244. It will be understood that the agent 253 or the processing system application 254 may be executable to initiate, perform, complete, and/or facilitate one or more portions of any embodiments described and/or contemplated herein. The agent 253 may comprise executable instructions associated with data processing and analysis related to brand elements and may be embodied within the processing system application 254 in some instances. The brand element protection system 200 may be owned by, operated by and/or affiliated with the same managing entity that owns or operates the managing entity system 500. In some embodiments, the brand element protection system 200 is fully integrated within the managing entity system 500.

The agent 253 may further comprise a data analysis module 260, a machine learning engine 261, and a machine learning dataset(s) 262. The data analysis module 260 may store instructions and/or data that may cause or enable the brand element protection system 200 to receive, store, and/or analyze data received by the managing entity system 500 or the database 300. The data analysis module may process data to identify product categories and subcategories as will be further discussed in FIG. 4. The machine learning engine 261 and machine learning dataset(s) 262 may store instructions and/or data that cause or enable the brand element protection system 200 to determine, in real-time and based on received information, instances of brand element use, as well as whether or not the use is authorized or unauthorized by the managing entity. In some embodiments, the machine learning engine 261 and machine learning dataset(s) 262 may store instructions and/or data that cause or enable the brand element protection system 200 to determine, in real-time and based on received information, a recommended remedial measure to be taken against unauthorized brand element usage. The machine learning dataset(s) 262 may contain data queried from database 300 or may be extracted or scraped from publicly viewable or accessible sources of information via network 101. The database 300 may also contain metadata related to instances of brand element usage (e.g., location, time, associated party, data format, color, certificate value, hash value, or the like). In some embodiments, the machine learning dataset(s) 262 may also contain data relating to user activity or device information, which may be stored in a user account managed by the managing entity system.

The machine learning engine 261 may receive data from a plurality of sources and, using one or more machine learning algorithms, may generate one or more machine learning datasets 262. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. It is understood that additional or alternative machine learning algorithms may be used without departing from the invention.

The machine learning datasets 262 may include machine learning data linking one or more details of brand element usage to identify one or more factors indicating whether or not the brand element is authorized for the specific use. For instance, the machine learning datasets 262 may include data linking a particular brand element to a particular set of parties, uses, time periods, formats, situations, or the like in which the brand element is authorized for use. Thus, this data may enable the brand element protection system 200 to identify with a percentage likelihood that a specific use of a brand element by a particular party in a particular manner either is or is not authorized by the managing entity. The data associated with a brand element or its instance of use may be supplemented by additional data obtained from the managing entity system 500 or third party systems 400. For example, in some embodiments, the system may determine, based on location data obtained from a third party system 400 server, that the location (e.g., geographic location, URL location, server address, or the like), of the brand element instance of use is not authorized by the managing entity. In other embodiments, the agent may rely on data from a third party system 400 such as a registry or domain name server which may authenticate a certificate of use of a particular brand element. that a user is in closer proximity to a first third party merchant than a second third party merchant. The brand element protection system 200 may weight that information accordingly to determine that the likelihood that a particular instance of brand element usage may be unauthorized.

The communication device 244 may generally include a modem, server, transceiver, and/or other devices for communicating with other devices on the network 101. The communication device 244 may be a communication interface having one or more communication devices configured to communicate with one or more other devices on the network 101, such as the brand element protection system 200, the user device 104, other processing systems, data systems, etc.

Additionally, referring to brand element protection system 200 illustrated in FIG. 2, the processing device 242 may generally refer to a device or combination of devices having circuitry used for implementing the communication and/or logic functions of the brand element protection system 200. For example, the processing device 242 may include a control unit, a digital signal processor device, a microprocessor device, and various analog-to-digital converters, digital-to-analog converters, and other support circuits and/or combinations of the foregoing. Control and signal processing functions of the brand element protection system 200 may be allocated between these processing devices according to their respective capabilities. The processing device 242 may further include functionality to operate one or more software programs based on computer-executable program code 252 thereof, which may be stored in a memory device 250, such as the processing system application 254 and the agent 253. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 242 may be configured to use the network communication interface of the communication device 244 to transmit and/or receive data and/or commands to and/or from the other devices/systems connected to the network 101.

The memory device 250 within the brand element protection system 200 may generally refer to a device or combination of devices that store one or more forms of computer-readable media for storing data and/or computer-executable program code/instructions. For example, the memory device 250 may include any computer memory that provides an actual or virtual space to temporarily or permanently store data and/or commands provided to the processing device 242 when it carries out its functions described herein.

FIG. 3 illustrates a block diagram of the user device associated with the brand element protection system, in accordance with embodiments of the present invention. The user device 104 may include a user mobile device or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, gaming devices, laptop computers, cameras, video recorders, audio/video player, radio, GPS devices, any combination of the aforementioned devices.

The user device 104 may generally include a processing device or processor 310 communicably coupled to devices such as, a memory device 350, user output devices 340 (for example, a user display or a speaker), user input devices 330 (such as a microphone, keypad, touchpad, touch screen, and the like), a communication device or network interface device 360, a positioning system device 320, such as a geo-positioning system device like a GPS device, an accelerometer, and the like, one or more chips, and the like.

The processor 310 may include functionality to operate one or more software programs or applications, which may be stored in the memory device 320. For example, the processor 310 may be capable of operating applications such as a user application 351, an entity application 352, or a web browser application. The user application 351 or the entity application may then allow the user device 104 to transmit and receive data and instructions to or from the third party system 400, brand protection system 200, and the managing entity system 500, and display received information via a graphical user interface of the user device 104. The user application 352 may further allow the user device 104 to transmit and receive data to or from the managing entity system 500 (for example, via wireless communication or NFC channels), data and instructions to or from the brand element protection system 200, web content, such as, for example, location-based content and/or other web page content, according to a Wireless Application Protocol (WAP), Hypertext Transfer Protocol (HTTP), and/or the like. The user application 352 may allow the managing entity 500 to present the user 102 with a plurality of recommendations, identified trends, suggestions, brand element data, pattern data, graph data, statistics, and/or the like for the user.

The processor 310 may be configured to use the communication device 360 to communicate with one or more devices on a network 101 such as, but not limited to the third party system 400, the brand element protection system 200, and the managing entity system 500. In this regard the processor 310 may be configured to provide signals to and receive signals from the communication device 360. The signals may include signaling information in accordance with the air interface standard of the applicable BLE standard, cellular system of the wireless telephone network and the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols and/or the like. For example, the user device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 104 may also be configured to operate in accordance with non-cellular communication mechanisms, such as via a wireless local area network (WLAN) or other communication/data networks. The user device 104 may also be configured to operate in accordance Bluetooth® low energy, audio frequency, ultrasound frequency, or other communication/data networks.

The communication device 360 may also include a user activity interface presented in user output devices 340 in order to allow a user 102 to execute some or all of the processes described herein. The application interface may have the ability to connect to and communicate with an external data storage on a separate system within the network 101. The user output devices 340 may include a display (e.g., a liquid crystal display (LCD) or the like) and a speaker 334 or other audio device, which are operatively coupled to the processor 310. The user input devices 330, which may allow the user device 104 to receive data from the user 102, may include any of a number of devices allowing the user device 104 to receive data from a user 102, such as a keypad, keyboard, touch-screen, touchpad, microphone, mouse, joystick, other pointer device, button, soft key, and/or other input device(s).

The user device 104 may also include a memory buffer, cache memory or temporary memory device 350 operatively coupled to the processor 310. Typically, one or more applications 351 and 352, are loaded into the temporarily memory during use. As used herein, memory may include any computer readable medium configured to store data, code, or other information. The memory device 350 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the brand element protection system 200 performing one or more steps described herein in conjunction with other devices and systems, either automatically based on executing computer readable instructions of the memory device 250, or in response to receiving control instructions from the managing entity system 500. In some instances, the system refers to the devices and systems on the operating environment 100 of FIG. 1. The features and functions of various embodiments of the invention are be described below in further detail.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 4 is a high-level process flow diagram illustrating a process using the brand element protection system, in accordance with one embodiment of the present disclosure. The process begins at block 600, where the system deploys the brand element agent 253 in order to gather information regarding instances of brand element use. The system identifies instances of potential brand element use via the agent 253. In some embodiments, the agent 253 may be an automated program designed to analyze information sources and capture snapshots (e.g., screenshots of a website, or the like) of brand use instances as determined based on identified statistical similarity of images to known brand elements, such as via the use of machine learning engine 261 in order to analyze images for contour analysis through a deep neural network (DNN) convolutional encoding decoding process. In other embodiments, for instance in the case of a technical brand element such as s URL or digital certificate, the agent 253 may be programmed to compare extracted information from an information source against a repository of information stored on the brand element protection system 200, managing entity system 500, or the third party system 400 (e.g., the agent 253 may compare extracted information from an information source to an inventory of all issued certificates and provenance tracking for downstream certificate issuance located in the brand element data repository 256, database 300, or the like). In some embodiments, the machine learning engine 261 may be used to generate a statistical likelihood that an instance is a use of a brand element, such as a weighted percentage score, or the like, indicating a confidence that the instance does include a brand element.

In some embodiments, the agent 253 may also be deployed internally within the managing entity system 500 in order to conduct real-time analysis of brand element misuse or unauthorized use. In this way, the system may proactively identify an emergent instance of potential brand element misuse before it is implemented. For instance, the managing entity system 500 may encompass an internal system for authorization of use of particular technical or non-technical brand elements. Such elements may be stored in a secure database of brand element files which may be monitored for authorized access and trigger alerts when these files are accessed or used by users 102. In some embodiments, metadata may be generated for each use-case of a brand element which the system may analyze or capture via the agent 253 in order to make a real-time determination of authorized or unauthorized use as the brand elements are accessed. In other embodiments, the managing entity system 500 may also comprise a system or policy for submitting brand element use approval before implementing brand elements. In this case, the agent 253 may be tasked with analyzing requests for brand element use, analyzing a log of historically approved use cases, or the like, in the process of making a determination as to the authorized or unauthorized nature of each use-case.

One the agent 253 has gathered information on potential instances of brand element use, the system may proceed to query the database 300 or datastore of the brand element protection system 200 in order to identify a brand element category or subcategory, as shown in block 620. For instance, the brand element may be categorized as non-technical or technical. Non-technical brand elements may include typical marks such as images, logos, or colors, while technical elements may include Domain Name System (DNS) information, digital certificates, Uniform Resource Locators (URLs), or the like, wherein any number of examples of technical or non-technical elements may represent a further subcategorization. As indicated in block 630, a category and subcategory are identified, the system may retrieve brand element data for the specific category and subcategory, such as the permissible instances wherein the brand element may be used, or the authorized parties which have license to use the brand element.

Next, as shown in block 640, the system may generate a machine learning dataset and remedial recommendation. As discussed previously, the machine learning engine 261 may be used to initially identify probable instances of brand element use; however, the machine learning engine may also be used to further confirm the suspected use as including a brand element based on intelligent comparison to existing categorization and subcategorization data. In some embodiments, the machine learning engine utilizes a plurality of neural network models which are compared and selected, or combined to produce the most accurate pattern recognition or predictive capability based on available data. In this way, an ensemble of models may be used to achieve the most accurate predictive results, and the ensemble may be adapted over time as needed. The machine learning engine may comprise a supervised or unsupervised machine learning model, or ensemble of models, in order to process incoming data in order to generate recommendations or recognize patterns in a dynamic fashion using a neural network architecture. The machine learning engine is configured to process a collection of data received by or stored on the system, which provides a wealth of available training data allowing the system to develop a high level of adaptability to constantly changing environments or a wide array of various system conditions, external application needs, or the like, as may be reflected in changes in a received data stream in real time. In some embodiments, the machine learning engine may include an adversarial neural network. For example, transformer-based, attention-based, and bi-directional Long Short Term Memory (LSTM) Deep learning based network models may be used for encoding and decoding for pattern detection and classification of potential brand element uses. This method incorporates the use of encoding and decoding in order to train one or more machine learning models and identify relevant patterns in received data from one or more channels of communication or extracted from the database 300. In some embodiments, different ensembles of similar machine learning models with different training characteristics may be combined to achieve a desired result or accuracy in data processing.

It is understood that the generation of the machine learning aggregated dataset and remedial recommendations form a core component of the system. For instances, the system may include a data normalization process by which the system aggregates the different data collected from the agent 253 and other data ingestion points, and determines appropriate association with other information collected about the same or other brand elements. It is understood that this normalization could be implemented in many different ways, but in some implementations the system might utilize correlation algorithms associated to metadata tags on brand elements. For example, digitally signed certificates have data around specific legal entities and those same legal entities might be represented with visual brand elements. A correlation algorithm would associate those sets of data using graph database technology and relationship edges with strength properties tied to the relative confidence in that association. In some embodiments, those edges would have a very strong correlation, as it is very likely that they are related to the same underlying brand elements. This information may be displayed in a graph database format for user visualization, as shown in block 650.

Finally, the system may initiate an automated remedial action. For instance, if through data collection and analysis the system identifies a brand element which is being misused, misrepresented, used without proper authorization, or is otherwise in some way requiring some remediation, the system may initiate automated action to downstream systems. Some implementation might include automated changes to systems such as certificate management technology systems (e.g., a certificate revocation list, or the like). In some embodiments, the system may forward a decision regarding a certificate revocation to a third party system 400 which is responsible for maintaining access to certificates. In other embodiments, remedial measures might include less technical measures, such as automating the generation and transmission of a cease-and-desist letter via one or more communication channels (e.g., email, physical letter mailing, automated phone call, or the like) to a third party identified as misrepresenting a brand element.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for enhanced brand element protection and automated response, the system comprising:
at least one non-transitory storage device; and
at least one processing device coupled to the at least one non-transitory storage device, wherein the at least one processing device is configured to:
receive data from one or more data gathering programs or third party sources, wherein the data represents potential brand element use;
query a database of existing brand element category examples and perform an analysis of the data in comparison to the brand element category examples via use of a machine learning algorithm;
determine a confidence score for the data indicating a percentage likelihood that the data represents use of one or more brand element categories;
determine that the use of the one or more brand element categories is unauthorized; and
generate an automated remedial action to stop the use of the one or more brand element categories.

2. The system of claim 1, wherein the one or more brand element categories comprises a non-technical brand element including a specific image, a specific logo, or specific color scheme.

3. The system of claim 1, wherein the one or more brand element categories comprises a technical brand element including DNS information, a digital certificate, a domain name, or a URL.

4. The system of claim 1, wherein the data is an image, and the machine learning algorithm comprises neural network image recognition via a convolutional neural network.

5. The system of claim 1, wherein determining that the use of the one or more brand element categories is unauthorized further comprises automatically comparing the data source to a list of authorized digital certificates.

6. The system of claim 1, further configured to:
detect legal entities associated with data from two separate sources and two different brand element categories;
determine via a correlation algorithm that the legal entities of the data of the two separate sources and two different brand element categories have some association;
generate a confidence score based on the association; and
display the association of the data in a graph database format for user visualization.

7. The system of claim 1, wherein the automated remedial action further comprises triggering an automatic generation of a cease and desist letter targeted to the source of the data.

8. A computer program product for enhanced brand element protection and automated response, the computer program product comprising at least one non-transitory computer-readable medium having computer-readable program code portions embodied therein, the computer-readable program code portions comprising:
an executable portion configured for receiving data from one or more data gathering programs or third party sources, wherein the data represents potential brand element use;
an executable portion configured for querying a database of existing brand element category examples and performing an analysis of the data in comparison to the brand element category examples via use of a machine learning algorithm;
an executable portion configured for determining a confidence score for the data indicating a percentage likelihood that the data represents use of one or more brand element categories;
an executable portion configured for determining that the use of the one or more brand element categories is unauthorized; and
an executable portion configured for generating an automated remedial action to stop the use of the one or more brand element categories.

9. The computer program product of claim 8, wherein the one or more brand element categories comprises a non-technical brand element including a specific image, a specific logo, or specific color scheme.

10. The computer program product of claim 8, wherein the one or more brand element categories comprises a technical brand element including DNS information, a digital certificate, a domain name, or a URL.

11. The computer program product of claim 8, wherein the data is an image, and the machine learning algorithm comprises neural network image recognition via a convolutional neural network.

12. The computer program product of claim 8, wherein determining that the use of the one or more brand element categories is unauthorized further comprises automatically comparing the data source to a list of authorized digital certificates.

13. The computer program product of claim 8, further configured to:
detect legal entities associated with data from two separate sources and two different brand element categories;
determine via a correlation algorithm that the legal entities of the data of the two separate sources and two different brand element categories have some association;
generate a confidence score based on the association; and
display the association of the data in a graph database format for user visualization.

14. The computer program product of claim 8, wherein the automated remedial action further comprises triggering an automatic generation of a cease and desist letter targeted to the source of the data.

15. A computer-implemented method for enhanced brand element protection and automated response, the method comprising:
providing a computing system comprising a computer processing device and a non-transitory computer readable medium, wherein the computer readable medium comprises configured computer program instruction code, such that when said instruction code is operated by said computer processing device, said computer processing device performs the following operations:
receiving data from one or more data gathering programs or third party sources, wherein the data represents potential brand element use;
querying a database of existing brand element category examples and performing an analysis of the data in comparison to the brand element category examples via use of a machine learning algorithm;
determining a confidence score for the data indicating a percentage likelihood that the data represents use of one or more brand element categories;
determining that the use of the one or more brand element categories is unauthorized; and
generating an automated remedial action to stop the use of the one or more brand element categories.

16. The computer-implemented method of claim 15, wherein the one or more brand element categories comprises a non-technical brand element including a specific image, a specific logo, or specific color scheme.

17. The computer-implemented method of claim 15, wherein the one or more brand element categories comprises a technical brand element including DNS information, a digital certificate, a domain name, or a URL.

18. The computer-implemented method of claim 15, wherein the data is an image, and the machine learning algorithm comprises neural network image recognition via a convolutional neural network.

19. The computer-implemented method of claim 15, wherein determining that the use of the one or more brand element categories is unauthorized further comprises automatically comparing the data source to a list of authorized digital certificates.

20. The computer-implemented method of claim 15, wherein the automated remedial action further comprises triggering an automatic generation of a cease and desist letter targeted to the source of the data.
